(19) United States
(12) Patent Application Publication
(10) Pub. No.: US 2003/0162435 A1
(43) Pub. Date: Aug. 28, 2003

(54) Cable connector hood and clamp

(76) Inventors: Glen Holman, Winter Springs, FL (US); Andrew Filtness, Longwood, FL (US); Larry W. Sutton, Eustis, FL (US); Thomas H. Singer, Oviedo, FL (US)

Correspondence Address: Elsa Keller, Siemens Corporation, Intellectual Property Department, 170 Wood Avenue South, Iselin, NJ, 08830, US

(21) Appl. No.: 10/365,314

(22) Filed: Feb. 12, 2003

Related U.S. Application Data
(60) Provisional application No. 60/356,278, filed on Feb. 12, 2002.
(60) Provisional application No. 60/356,498, filed on Feb. 12, 2002.

(51) Int. Cl. H01R 13/58

(52) U.S. Cl. 439/466

(57) ABSTRACT

Certain exemplary embodiments of the present invention provide a device comprising a hood attachable to a cable connector for a first cable, the cable connector attachable to a substantially planar first circuit card, said hood attachable in a plane of the first circuit card, said hood adapted to constrain a portion of the first cable to within a predetermined volume partially defined by a thickness of the first circuit card, said hood adapted to constrain a portion of a second cable to within the predetermined volume. It is emphasized that this abstract is provided to comply with the rules requiring an abstract that will allow a searcher or other reader to quickly ascertain the subject matter of the technical disclosure. This abstract is submitted with the understanding that it will not be used to interpret or limit the scope or meaning of the claims.

### CROSS-REFERENCE TO RELATED APPLICATIONS

This application is related to and claims the benefit of commonly-owned U.S. Provisional Application Nos. 60/356,278 and 60/356,498, both filed Feb. 12, 2002, titled “Cable Connector Hood” and “Clip for a Cable Connector” respectively both of which are incorporated by reference herein in their entirety.

### BACKGROUND

Networks can be found in many environments, including computer equipment rooms, telephone provider central offices and/or switching centers, and/or manufacturing plant instrumentation centers and/or control rooms. Frequently, networks include at least one line card or circuit card that conditions, modifies, and/or processes a signal, noise, interference, etc. traveling on a circuit of the network.

Each circuit card can be mounted in a rack or other multi-card mounting structure containing a multitude of other circuit cards. Under certain circumstances, it can be desirable to mount such circuit cards as closely together as possible, to conserve valuable space in such environments. When circuit cards are mounted closely together, however, one or more cables connected to a given card can become tangled and/or interfere with access to adjacent cards. Also, such close spacing of circuit cards and cables can create forces that can cause a cable to become unplugged from its respective circuit card.

U.S. Pat. No. 3,960,425, issued to Kirk et al., allegedly discloses that “a harness cable connector is shown which receives a plurality of insulated wires by a press fit for retaining the wires in a spaced configuration during insertion and assembly of the wires in a printed circuit board. The cable connector is then rolled and locked into the printed circuit board to provide strain relief for the harness cable.” See Abstract.

U.S. Pat. No. 6,350,147, issued to Brownell et al., allegedly discloses that “[t]here is provided a high density electrical connector for use on a panel which receives a plurality of closely spaced connectors. The connector includes two intermateable halves. One of the connector halves includes an elongated base having wire termination members on one side and associated electrical contacts on the other side. A hood covers the wire termination side of the base. An electrical cable containing a plurality of insulated wires enters on the side of the hood adjacent to a closely spaced adjoining connector at an angle greater than 0.degree. but less than 90.degree. with respect to the base so that the cable will clear the adjoining connector without the need to unduly bend the cable. The top of the hood may be sloped downwardly from its cable receiving side to the opposing side.” See Abstract.

### SUMMARY

Certain exemplary embodiments of the present invention provide a system comprising a hood attachable to a cable connector for a first cable, the cable connector attachable to a card connector of a first circuit card having a length, a width, and thickness, the first circuit card lengthwise mountable in a multi-card mounting structure, the hood comprising a substantially parallel pair of substantially planar sides adapted to constrain a predetermined portion of the first cable to within a predetermined volume having a volume thickness defined by the thickness of the first circuit card, the sides of the hood connected by a back adapted to separate a predetermined portion of a second cable associated with a second circuit card from the predetermined portion of the first cable, the back of the hood sloped at an angle of greater than 0 degrees and less than approximately 45 degrees with respect to the thickness of the first circuit card, the back of the hood connected to a substantially parallel pair of side extensions adapted to constrain the predetermined portion of the second cable to within the predetermined volume, each of the sides of the hood comprising a recess adapted to receive a protrusion of a hood clamp extending from the first circuit card.

Certain exemplary embodiments of the present invention provide a system comprising a hood attachable to a cable connector for a first cable, the cable connector attachable to a card connector of a first circuit card, said hood comprising a substantially parallel pair of substantially planar sides adapted to constrain a portion of the first cable to within a predetermined volume having a thickness defined by a thickness of the first circuit card, said sides connected by a back adapted to separate a portion of a second cable from the first cable, said back sloped at a maximum angle of less than 60 degrees with respect to a thickness of the first circuit card, said back connected to a substantially parallel pair of side extensions adapted to constrain the portion of the second cable to within the predetermined volume, each of said sides comprising a recess adapted to receive a protrusion of a hood clamp extending from the first circuit card.

Certain exemplary embodiments of the present invention provide a device comprising a hood attachable to a cable connector for a first cable, the cable connector mateable to a card connector in a plane of a substantially planar first circuit card, said hood adapted to resist de-mating of the cable connector from the card connector, said hood adapted to constrain a portion of the first cable to within a first predetermined volume partially defined by a thickness of the first circuit card.

Certain exemplary embodiments of the present invention provide a device comprising a hood for a cable connector for a first cable, the cable connector attached to a first circuit card, a sloped back of said hood separating a portion of the first cable from a portion of a second cable, said hood constraining the portion of the first cable and the portion of the second cable to within a predetermined volume partially defined by a thickness of the first circuit card, the predetermined volume extending substantially perpendicular to a length of the first circuit card.

Certain exemplary embodiments of the present invention provide a device comprising a hood attachable to a cable connector for a first cable, the cable connector attachable to a first circuit card, said hood adapted to constrain a portion of the first cable to within a predetermined volume partially defined by a thickness of the first circuit card, said hood adapted to constrain a portion of a second cable to within the predetermined volume.

Certain exemplary embodiments of the present invention provide a device comprising a hood attachable to a cable connector for a first cable, the cable connector attachable to a substantially planar first circuit card, said hood attachable in a plane of the first circuit card, said hood adapted to constrain a portion of the first cable to within a predetermined volume partially defined by a thickness of the first circuit card, said hood adapted to constrain a portion of a second cable to within the predetermined volume.

Certain exemplary embodiments of the present invention provide a method comprising mating a cable connector of a first cable to a card connector attached to a substantially planar first circuit card in a plane of the first circuit card, and placing a hood over the cable connector, the hood attached to a second cable.

### BRIEF DESCRIPTION OF THE DRAWINGS

The invention and its wide variety of potential embodiments will be readily understood via the following detailed description of certain exemplary embodiments, with reference to the accompanying drawings in which:

FIG. 1 is a perspective view of an exemplary embodiment of a system 1000 of the present invention;

FIG. 2 is a front view of an exemplary embodiment of a system 1000 of the present invention;

FIG. 3 is a top view of an exemplary embodiment of a system 1000 of the present invention;

FIG. 4 is a right perspective view of an exemplary embodiment of a device 2000 of the present invention;

FIG. 5 is a left perspective view of an exemplary embodiment of a device 2000 of the present invention;

FIG. 6 is a back perspective view of an exemplary embodiment of a device 2000 of the present invention;

FIG. 7 is a left view of an exemplary embodiment of a device 2000 of the present invention;

FIG. 8 is a perspective view of an exemplary embodiment of a system 3000 of the present invention; and

FIG. 9 is a perspective view of an exemplary embodiment of a device 4000 of the present invention.

### DETAILED DESCRIPTION

When circuit cards are mounted closely together, it can be desirable to provide a means for preventing one or more cables connected to a card from becoming tangled and/or from interfering with access to adjacent cards. In certain situations, it can be desirable to provide a means for preventing one or more cables connected to a card from becoming unplugged from its respective circuit card.

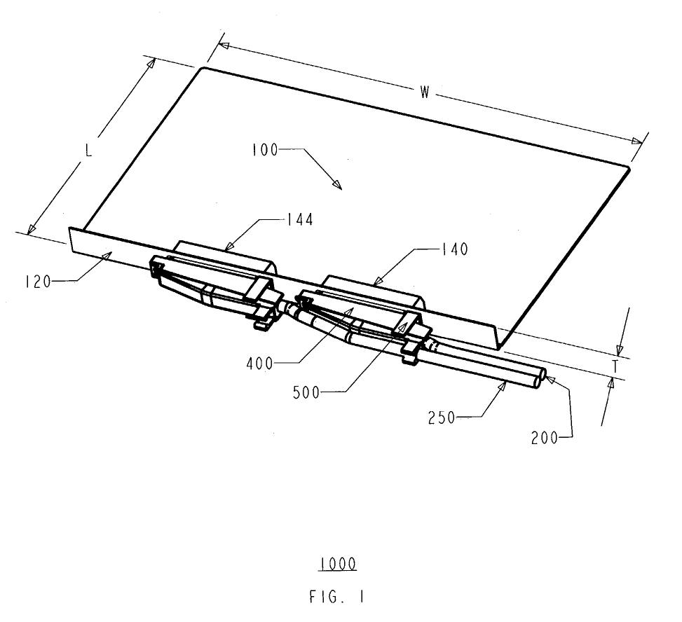

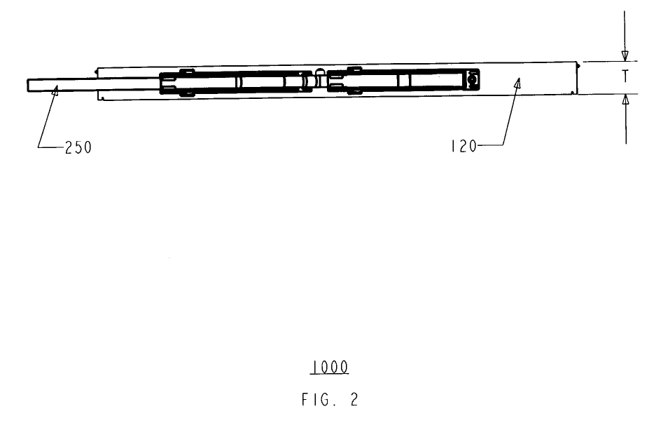

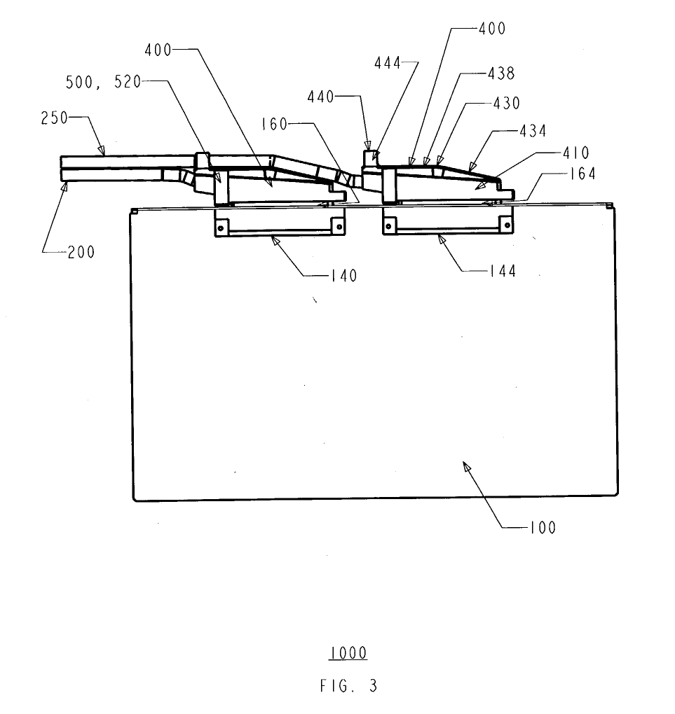

FIG. 1 is a perspective view, FIG. 2 is a front view, and FIG. 3 is a top view of an exemplary embodiment of a system 1000 of the present invention. System 1000 can include a substantially planar circuit card 100, having a length L, a width W, and a thickness T. Circuit card 100 can include one or more printed circuits attached via a card connector 140 to a faceplate 120. Circuit card 100 can be suitable for mounting in a multi-card rack.

A first cable 200 can be attached and/or attachable to first card connector 140 and/or faceplate 120 via a first cable connector 160. Likewise, a second cable 250 can be attached and/or attachable to second card connector 144 and/or faceplate 120 via a second cable connector 164. First cable 200 and/or second cable 250 can exit card 100 perpendicular to a length of card 100. In an alternative embodiment (not shown), second cable 250 can be attached to a second adjacent and/or co-planar circuit card (not shown). In an alternative embodiment, second cable 250 is not attached to card 100.

A hood 400 can be installed over first cable connector 160. Hood 400 can at least partially define a path for at least a portion of first cable 200, which can include a predetermined portion of first cable 200. Hood 400 can constrain at least a portion of first cable 200 to a first predetermined and/or predefined volume, such as a volume at least partially defined by the thickness T of circuit card 100. The first predetermined volume can extend along a width of circuit card 100, and possibly can extend further, such as for between approximately 0.25 and approximately 24 inches, and any value therebetween, including for example, approximately 0.5, 0.76, 1, 1.48, 2, 2.51, 3.02, 4, 4.97, 6.002, 8, 10, 12.1, 14, 16, 18, and/or 22.03, etc. inches. The first predetermined volume can extend beyond circuit card 100, in the direction of length L, by a predetermined distance, such as for example, between approximately 1 inches and approximately 8 inches, and any value therebetween, including for example, approximately 1.5, 2, 2.25, 3, 3.17, 3.5, 3.95, and/or 4.5 etc. inches.

Hood 400 can at least partially define a path for at least a portion of second cable 250, which can include a predetermined portion of second cable 250. Hood 400 can at least partially constrain at least a portion of second cable 250 to a second predetermined and/or predefined volume, such as a volume at least partially defined by the thickness T of circuit card 100. The second predetermined volume can extend along a width of circuit card 100, and possibly can extend further, such as for between approximately 0.25 and approximately 24 inches, and any value therebetween, including for example, approximately 0.5, 0.76, 1, 1.48, 2, 2.51, 3.02, 4, 4.97, 6.002, 8, 10, 12.1, 14, 16, 18, and/or 22.03, etc. inches. The second predetermined volume can extend beyond circuit card 100, in the direction of length L, by a predetermined distance, such as for example, between approximately 1 inches and approximately 8 inches, and any value therebetween, including for example, approximately 1.5, 2, 2.25, 3, 3.17, 3.5, 3.95, and/or 4.5 etc. inches. The second predetermined volume can be identical to, a subset of, include, partially include, intersect, and/or be substantially adjacent to the first predetermined volume.

Hood 400 can separate at least a portion of first cable 200 from at least a portion of second cable 250. At least a portion of first cable 200 and/or at least a portion of second cable 250 can extend across at least a portion of a width W of card 100, such that a longitudinal axis of at least a portion of cable 200 and/or at least a portion of cable 250 is substantially parallel to width W.

A hood clamp 500 can be attached to circuit card 100, faceplate 120, card connector 140, and/or hood 400. Hood clamp 500 can releasably secure hood 400 to circuit card 100, faceplate 120, and/or card connector 140. Hood clamp 500 can prevent de-mating and/or partial de-mating of hood 400 from first cable connector 160, which could impact a path of first cable 200 and/or second cable 250. Hood clamp 500 can prevent de-mating and/or partial de-mating of first cable connector 160 from first card connector 140, which could cause a circuit interruption.

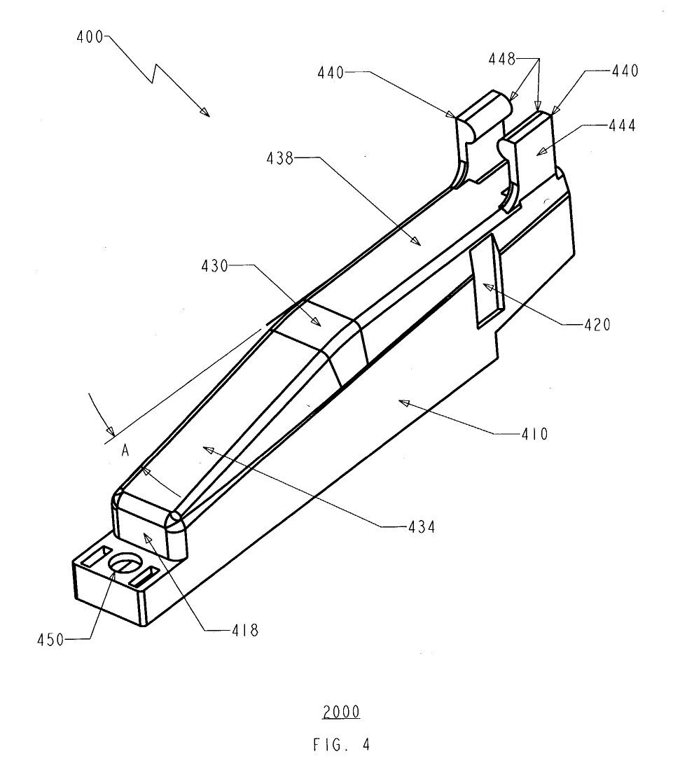

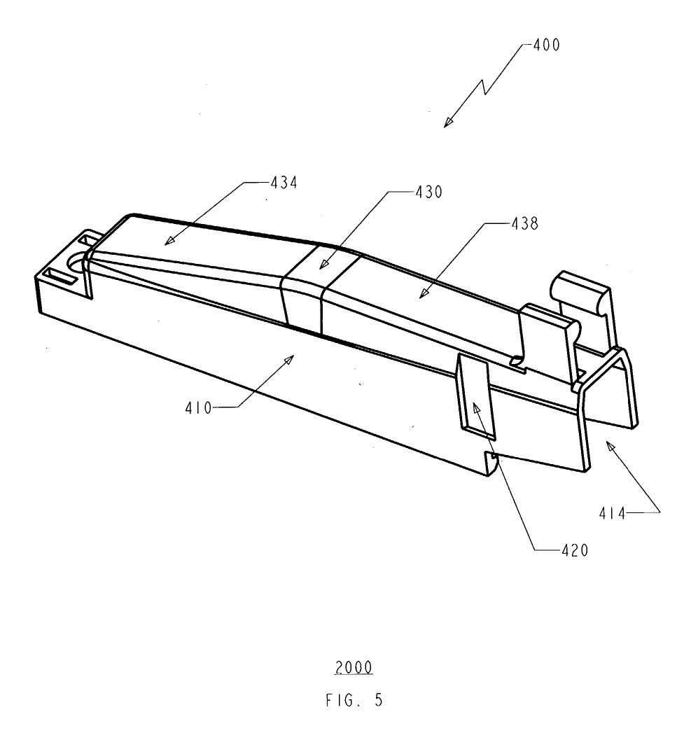

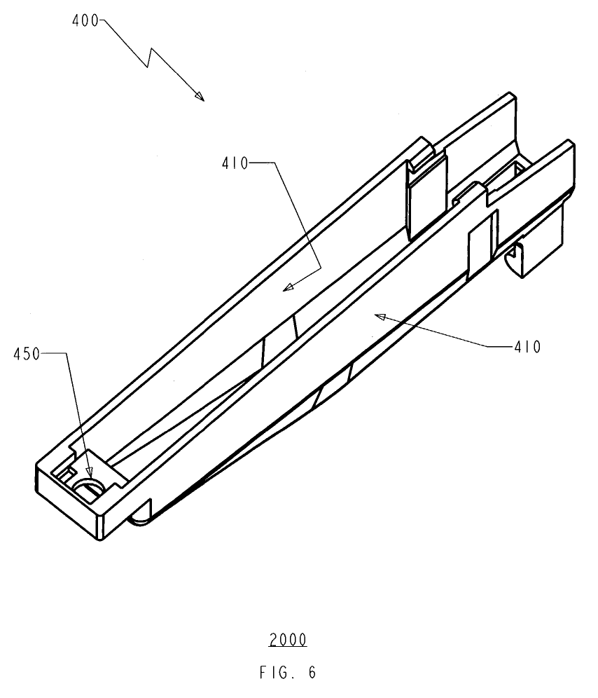

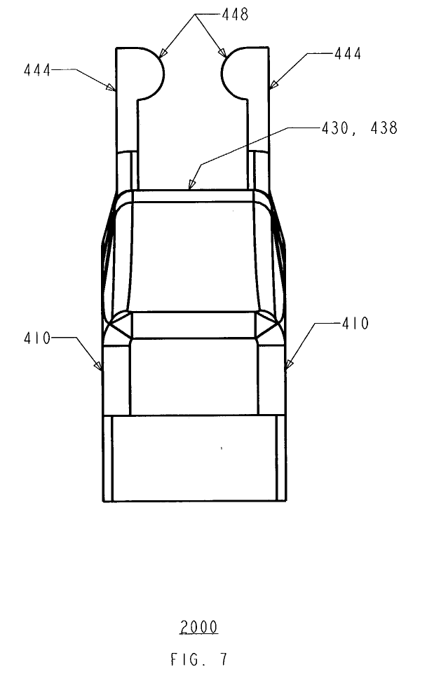

FIG. 4 is a right perspective view, FIG. 5 is a left perspective view, and FIG. 6 is a back perspective view, and FIG. 7 is a left view of an exemplary embodiment of a device 2000 of the present invention. Referring to FIGS. 4-7, device 2000 can include a hood 400, such as that described with reference to FIGS. 1-3.

Hood 400 can have a pair of substantially planar, substantially parallel sides 410 that extend in parallel planes to circuit card 100. Attached to sides 410 can be a hood back 430. Hood 430 can have an open exit end 414, and an opposed closed end 418. Back 430 can at least partially define a path for second cable 250. Back 430 can have a sloped back portion 434 that can relieve strain and/or stress from second cable 250 where it passes over hood 400. Back 430 can also have a flat back portion 438. Sloped back portion 434 can be angled with respect to flat back portion 438, the faceplate, and/or a thickness of the circuit card, at an angle A. The value of angle A can fall between approximately 60 degrees and 0 degrees, including all values therebetween, such as for example, 52, 45, 37.5, 30, 25.1, 22.5, 19.9, 15, 13.4, 10, 7.5, etc. degrees. In an alternative embodiment, back 430 is curved, such that angle A varies from within a range of approximately 90 degrees to approximately 0 degrees, including all values therebetween. Thus, in an exemplary alternative embodiment, angle can vary from approximately 60 degrees to approximately 3.4 degrees, or approximately 51 degrees to approximately 0 degrees, etc. along back 430.

Each side 410 of hood 400 can define a recess 420 for receiving a hood clamp 500 (shown in FIGS. 1 and 3). A first end of hood 400, adjacent and/or near sloped back portion 434, can define a screw hole for attaching hood 400 to circuit card 100, faceplate 120, and/or card connector 140.

A second cable constrainer 440 can be integral and/or attached to a second end of hood 400, adjacent and/or near flat back portion 438. Second cable constrainer 440 can include a pair of substantially planar, substantially parallel side extensions 444 that extend in parallel planes to circuit card 100, and can be co-planar with sides 410. Attached to each side extension 444 can be a protrusion 448, which can be shaped as for example, a hemisphere or a half-cylinder. In an operative mode, protrusions 448 can provide a flexible interference fit with second cable 250, such that once forced between protrusions 448, removal of second cable 250 from between protrusions 448 requires a moderate force. Thus, second cable 250 can be unlikely to easily escape from between protrusions 448, and thereby, second cable constrainer 440 can at least partially define a path for second cable 250.

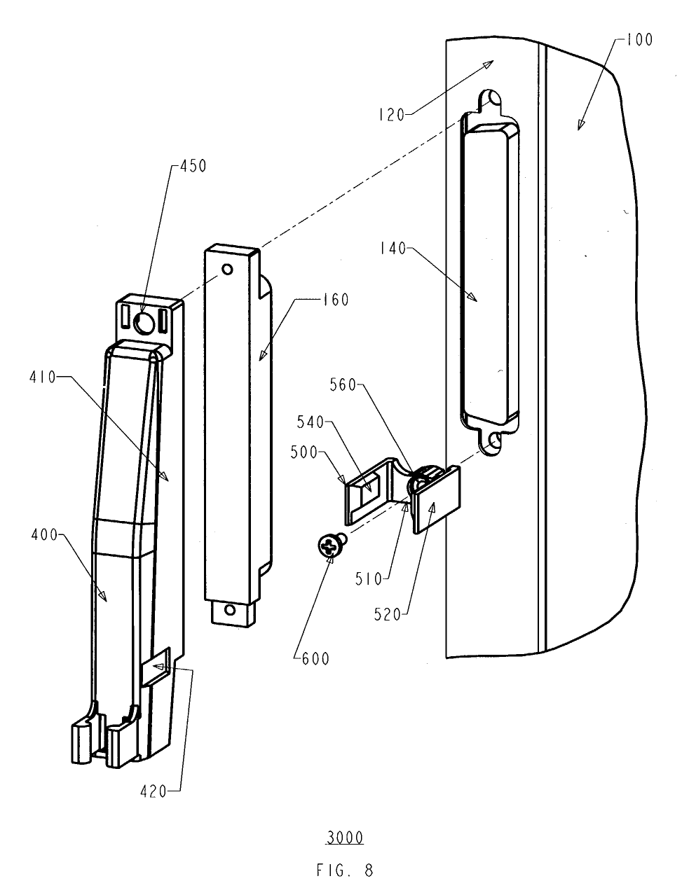

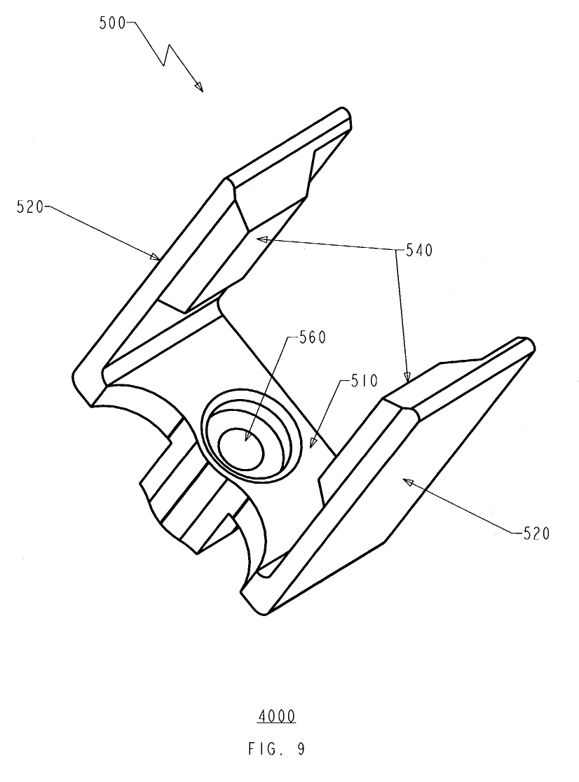

FIG. 8 is a perspective view of an exemplary embodiment of a system 3000 of the present invention, and FIG. 9 is a perspective view of an exemplary embodiment of a device 4000 of the present invention. As shown, a circuit card 100 can include a faceplate 120 and/or a card connector 140. A cable connector (shown in FIG. 3) can attach a first cable (shown in FIG. 3) to card connector 140. Hood 400 can cover a substantial portion of the cable connector. Hood 400 and/or hood clamp 500 can provide a means for attaching an open end of hood 400 to the cable connector, the card connector, the circuit card, and/or the faceplate. Such attaching means can include any number of attachment mechanisms, including a protrusion, a recess, a flexible retainer, and/or a hook and loop fastener system, etc.

As shown, defined in at least one side 410 of hood 400 can be a recess 420 for receiving and/or interfacing with a protrusion 540 of a hood clamp 500. Protrusion 540 can extend from a side 520 of hood clamp 500, which can have two substantially planar, parallel sides 520 connected by a bottom 510. Each of sides 520 can have a protrusion 540. In an alternative embodiment, hood 400 can include a protrusion that interfaces and/or mates with a recess in hood clamp 500.

Through bottom 510 can extend a screw hole 560 via which a screw 600 can attach hood clamp 500 to card connector 140. Likewise, an opposite end of hood 400 can be attached to card connector 140 via a screw (not shown). In certain embodiments, hood 400 and/or hood clamp 500 can be attached to circuit card 100 and/or faceplate 120.

Although the invention has been described with reference to specific exemplary embodiments thereof, it will be understood that numerous variations, modifications and additional embodiments are possible, and accordingly, all such variations, modifications, and embodiments are to be regarded as being within the spirit and scope of the invention. Also, references specifically identified and discussed herein are incorporated by reference as if fully set forth herein. Accordingly, the drawings and descriptions are to be regarded as illustrative in nature, and not as restrictive.

What is claimed is:

1. A system comprising a hood attachable to a cable connector for a first cable, the cable connector attachable to a card connector of a first circuit card having a length, a width, and thickness, the first circuit card lengthwise mountable in a multi-card mounting structure, the hood comprising a substantially parallel pair of substantially planar sides adapted to constrain a predetermined portion of the first cable to within a predetermined volume having a volume thickness defined by the thickness of the first circuit card, the sides of the hood connected by a back adapted to separate a predetermined portion of a second cable associated with a second circuit card from the predetermined portion of the first cable, the back of the hood sloped at an angle of greater than 0 degrees and less than approximately 45 degrees with respect to the thickness of the first circuit card, the back of the hood connected to a substantially parallel pair of side extensions adapted to constrain the predetermined portion of the second cable to within the predetermined volume, each of the sides of the hood comprising a recess adapted to receive a protrusion of a hood clamp extending from the first circuit card.

2. A system comprising a hood attachable to a cable connector for a first cable, the cable connector attachable to a card connector of a first circuit card, said hood comprising a substantially parallel pair of substantially planar sides adapted to constrain a portion of the first cable to within a predetermined volume having a thickness defined by a thickness of the first circuit card, said sides connected by a back adapted to separate a portion of a second cable from the first cable, said back sloped at a maximum angle of less than 60 degrees with respect to a thickness of the first circuit card, said back connected to a substantially parallel pair of side extensions adapted to constrain the portion of the second cable to within the predetermined volume, each of said sides comprising a recess adapted to receive a protrusion of a hood clamp extending from the first circuit card.

3. A device, comprising:
a hood attachable to a cable connector for a first cable, the cable connector mateable to a card connector in a plane of a substantially planar first circuit card, said hood adapted to resist de-mating of the cable connector from the card connector, said hood adapted to constrain a portion of the first cable to within a first predetermined volume partially defined by a thickness of the first circuit card.

4. The device of claim 3, said hood adapted to constrain a portion of a second cable to within the first predetermined volume.

5. The device of claim 3, said hood adapted to guide a portion of a second cable to within a second predetermined volume adjacent the first predetermined volume.

6. A device, comprising:
a hood for a cable connector for a first cable, the cable connector attached to a first circuit card, a sloped back of said hood separating a portion of the first cable from a portion of a second cable, said hood constraining the portion of the first cable and the portion of the second cable to within a predetermined volume partially defined by a thickness of the first circuit card, the predetermined volume extending substantially perpendicular to a length of the first circuit card.

7. A device, comprising:
a hood attachable to a cable connector for a first cable, the cable connector attachable to a first circuit card, said hood adapted to constrain a portion of the first cable to within a predetermined volume partially defined by a thickness of the first circuit card, said hood adapted to constrain a portion of a second cable to within the predetermined volume.

8. A device, comprising:
a hood attachable to a cable connector for a first cable, the cable connector attachable to a substantially planar first circuit card, said hood attachable in a plane of the first circuit card, said hood adapted to constrain a portion of the first cable to within a predetermined volume partially defined by a thickness of the first circuit card, said hood adapted to constrain a portion of a second cable to within the predetermined volume.

9. The device of claim 8, said hood comprising a substantially parallel pair of substantially planar sides adapted to constrain a portion of the first cable to within the predetermined volume.

10. The device of claim 8, said hood comprising a pair of sides, each of said sides comprising a recess adapted to receive a protrusion of a hood clamp extending from the first circuit card.

11. The device of claim 8, said hood comprising a pair of sides, each of said sides comprising a protrusion adapted to interface with a recess of a hood clamp extending from the first circuit card.

12. The device of claim 8, said hood comprising a pair of sides, each of said sides comprising a recess adapted to receive a protrusion of a hood clamp extending from a faceplate of the first circuit card.

13. The device of claim 8, said hood comprising a pair of sides, each of said sides comprising a protrusion adapted to interface with a recess of a hood clamp extending from a faceplate of the first circuit card.

14. The device of claim 8, said hood comprising a pair of sides, each of said sides comprising a recess adapted to receive a protrusion of a hood clamp extending from the cable connector.

15. The device of claim 8, said hood comprising a pair of sides, each of said sides comprising a protrusion adapted to interface with a recess of a hood clamp extending from the cable connector.

16. The device of claim 8, said hood comprising a pair of sides, each of said sides comprising a means for interfacing with a hood clamp that is at least indirectly coupleable to the first circuit card.

17. The device of claim 8, said hood comprising a pair of sides adapted to constrain a portion of the first cable to within the predetermined volume, said sides connected by a back.

18. The device of claim 8, said hood comprising a pair of sides adapted to constrain a portion of the first cable to within the predetermined volume.

19. The device of claim 8, said hood comprising a back adapted to separate a portion of the second cable from a portion of the first cable.

20. The device of claim 8, said hood comprising a back sloped with respect to a faceplate of the first circuit card.

21. The device of claim 8, said hood comprising a back, at least a portion of said back sloped with respect to a substantially planar faceplate of the first circuit card at a maximum angle of less than approximately 45 degrees.

22. The device of claim 8, said hood comprising a back, at least a portion of said back sloped with respect to a substantially planar faceplate of the first circuit card at a maximum angle of less than approximately 30 degrees.

23. The device of claim 8, said hood comprising a pair of side extensions adapted to constrain a portion of the second cable to within the predetermined volume.

24. The device of claim 8, said hood comprising a substantially parallel pair of side extensions.

25. The device of claim 8, said hood comprising a back and a pair of side extensions connected to said back.

26. The device of claim 8, said hood adapted to resist de-mating of the cable connector from the first circuit card.

27. The device of claim 8, said hood adapted to resist de-mating of the cable connector from a card connector of the first circuit card.

28. The device of claim 8, wherein the first circuit card and a second circuit card are substantially co-planar.

29. The device of claim 8, the first circuit card having a length, and lengthwise mountable in a multi-card mounting structure.

30. A method, comprising:
mating a cable connector of a first cable to a card connector attached to a substantially planar first circuit card in a plane of the first circuit card; and
placing a hood over the cable connector, the hood attached to a second cable.

31. The method of claim 30, further comprising releasably securing the hood to the first circuit card.

32. The method of claim 30, further comprising releasably securing the hood to the cable connector.

33. The method of claim 30, further comprising positioning the hood to constrain a portion of the first cable to within a first predetermined volume partially defined by the first circuit card.

34. The method of claim 30, further comprising positioning the hood to constrain a portion of a second cable to within a first predetermined volume partially defined by the first circuit card.

35. The method of claim 30, further comprising positioning the hood to constrain a portion of a second cable associated with a second circuit card to within a first predetermined volume partially defined by the first circuit card.

36. The method of claim 30, further comprising positioning the hood to relieve strain on a portion of a second cable.
